(19) United States
(12) Patent Application Publication
(10) Pub. No.: US 2022/0366070 A1
(43) Pub. Date: Nov. 17, 2022

(54) Securing Sensitive Data Executed By Program Scripts In A Computing Device

(71) Applicant: Oliver Fritz Glas, Zurich (CH)

(72) Inventor: Oliver Fritz Glas, Zurich (CH)

(21) Appl. No.: 17/302,868

(22) Filed: May 14, 2021

(51) Int. Cl. G06F 21/62; G06F 21/60; G06F 21/31

(52) U.S. Cl. CPC G06F 21/6227; G06F 21/602; G06F 21/604; G06F 21/31; G06F 2221/0751

(57) ABSTRACT

The present invention relates to the security of sensitive data executed by program files in a computing device. A first file comprising of a sequence of instructions that can be configured onto the memory and executed by a processor is stored in a storage device of the device. A suitable program comprising a sequence of instructions is configured on memory and coupled to an encrypted credential store only accessible to the program instance being executed by a processor. A encrypted data store coupled to above said program is provided on the device's storage device. The successful execution of said first file requires access to sensitive data such as but not limited to passwords, API keys or other sensitive parameters, which are provided at run-time by the program coupled to the encrypted credential store.

### TECHNICAL FIELD

The present invention, in some embodiments thereof, relates to the security of sensitive data executed by program files in a computing device, and more specifically to securing sensitive data executed by program files in a computing device's.

### RELATED APPLICATIONS

In some aspects, this application may claim benefit, directly or indirectly from several patent applications and prior art literature including:

US20050091655A1: Maintaining a set of runtime objects. A method of the invention detects creation of a runtime object by an application program or operating system. The method evaluates a predicate for a set associated with the runtime object to determine membership of the runtime object in the set. Further, one or more properties of the set may be applied to the determined runtime object members of the set (e.g., to control access to a resource).

U.S. Pat. No. 7,925,881B2: A method and apparatus for preventing rogue implementations of a security-sensitive class interface are provided. With the method and apparatus, a unique identifier (UID) is created by a server process when the server process is started. Anytime the server process, i.e. a server runtime environment, instantiates a new credential object following start-up of the server process, the encrypted UID is placed into a private field within the new credential object. In addition, the UID is encrypted and stored in a private class of the server runtime environment. A verification class is provided within the server runtime environment which includes one or more methods that receive the credential object as a parameter and return true or false as to the validity of the credential object. These one or more methods determine the validity of the credential object by retrieving the encrypted UID from the private class stored in the server runtime environment, decrypting the UID and comparing it to the decrypted UID stored in the private field of the credential object. If the two UIDs match, a determination is made that the credential object was created by the server runtime environment rather than a rogue application. If the two UIDs do not match, or if there is no UID in the credential object, then a false result will be returned by the verification class.

U.S. Ser. No. 10/838,758B2: Disclosed is a system comprising a physical memory, a processor and a software component. The software component includes a policy/domain handler for receiving data and a policy associated with the data; a hypervisor; and a file management module. The file management module receives a request from a third-party application to interact with a data file containing the data; sends an authorization and tag request to the policy/domain handler to check if the user and application are permitted to access the data, and if permitted, to generate hardware tags for the data file; and sends a secure data request to the hypervisor to create a secure data compartment for the data file and the hardware tags. Based on the authorization and tag request, and the security policy associated with the data, the policy/domain handler generates the hardware tags for the data file. Based on the secure data request, the hypervisor creates in the physical memory a secure data compartment containing the data file and the hardware tags, the hypervisor associating the hardware tags with the data in the secure data compartment. As the data is operated upon and moved to other memory areas, the hardware tags are propagated with the data according to tag propagation rules, and checked before performing operations that may lead to security breaches.

US20190073473A1: A system and method for dynamic security domain data protection through passive monitoring of data storage. The present invention may be implemented using data breakpoints to trigger invocation of the data flow analysis routines. A data breakpoint register may be associated with the memory location of each item of target data. Upon attempted access, a data breakpoint interrupt is triggered, which pauses execution and runs data flow analysis and security routines to determine the appropriate action. The present invention may be implemented using a virtual paging system having a memory management unit configured to generate a page fault upon any attempt to access target data. The virtual paging system may have a virtual page that contains target data and that page may be actively managed so that each attempted access to target data results in a page fault, which pauses execution and runs data flow analysis routines to determine appropriate action.

US20030159056A1: An embedded security subsystem, and method for implementing the same, which provide secure controllability of a data security device within a data processing system. The embedded security subsystem of the present invention includes a persistent enable flag for providing control access to the data security device, wherein the persistent enable flag is accessible only in response to a power-on reset cycle of the data processing system. The persistent enable flag is read-only accessible to runtime program instructions. A pending state change flag that is write accessible by runtime program instructions is utilized for setting an intended next state of the persistent enable flag such that control access to the data security device is enabled only during a subsequent power-on reset of said data processing system.

U.S. Pat. No. 7,603,704B2: Hijacking of an application is prevented by monitoring control flow transfers during program execution in order to enforce a security policy. At least three basic techniques are used. The first technique, Restricted Code Origins (RCO), can restrict execution privileges on the basis of the origins of instruction executed. This distinction can ensure that malicious code masquerading as data is never executed, thwarting a large class of security attacks. The second technique, Restricted Control Transfers (RCT), can restrict control transfers based on instruction type, source, and target. The third technique, Un-Circumventable Sandboxing (UCS), guarantees that sandboxing checks around any program operation will never be bypassed.

U.S. Ser. No. 10/028,144B2: A wireless end-user device has a wireless wide-area network (WWAN) modem and multiple execution environments. Applications execute in an application execution partition. A kernel execution partition executes processes for classifying, by application, traffic passing between the WWAN modem and the applications, measuring per-application traffic, and applying per-application traffic policies to the traffic. A separate protected execution partition contains agents to receive the traffic measurements, configure the traffic policies, and securely communicate with a network service controller. Low-level traffic measurement and control is advantageously and efficiently performed in the kernel, while the traffic-management processes that interface with the kernel are separately secured to resist hacking.

U.S. Ser. No. 10/009,173B2: Devices, system, and methods of secure entry and handling of passwords and Personal Identification Numbers (PINs), as well as for secure local storage, secure user authentication, and secure payment via mobile devices and via payment terminals. A computing device includes: a secure storage unit to securely store a confidential data item; a non-secure execution environment to execute program code, the program code to transport to a remote server a message; a secure execution environment (SEE) to securely execute code, the SEE including: a rewriter module to securely obtain the confidential data item from the secure storage, and to securely write the confidential data item into one or more fields in said message prior to its encrypted transport to the remote server.

U.S. Ser. No. 10/552,193B2: A system for providing security mechanisms for secure execution of program code is described. The system may be configured to maintain a plurality of virtual machine instances. The system may be further configured to receive a request to execute a program code and allocate computing resources for executing the program code on one of the virtual machine instances. One mechanism involves executing program code according to a user-specified security policy. Another mechanism involves executing program code that may be configured to communicate or interface with an auxiliary service. Another mechanism involves splitting and executing program code in a plurality of portions, where some portions of the program code are executed in association with a first level of trust and some portions of the program code are executed with different levels of trust.

### BACKGROUND OF THE INVENTION

Sensitive data exposure is currently at number 3 in the OWASP Top 10 list of the most critical application security risks. It is the aim of this disclosure, to describe one of the most common scenarios of incorrect sensitive data handling and suggest ways to protect sensitive data. Specifically, that has to do with the access of sensitive data by a program script being executed by the processor of a computing device. OWASP lists passwords, credit card numbers, health records, personal information and business secrets as sensitive data. However, social security numbers, passwords, biometric data, trade memberships and criminal records can also be thought of at sensitive data. There are many laws relating to the exposure of sensitive data in most countries. While the law may not enforce strict measures around sensitive data that your application creates or stores for its users, breaching that data would still hurt your users and, by extension, your business.

The software applications that run on our servers to provide services that run the internet are typically stored as scripts executed by the predecessors. Such scripts are often stored in clear text together with username and password, or any such sensitive data such as API keys and other access credentials. The problem is, that they cannot be encrypted to hide the sensitive date, and even if they are it would be without much use, because the script needs to be decrypted during the time of execution still exposing the sensitive date. Furthermore, even if the data were encrypted, the script would have to know the key to get the data, which again needs to be accessible without encryption at runtime. That mans that the script would require to store the decryption keys in clear text. Application data (such as session IDs and encryption keys) that helps protect user data from being exposed are also nor protected at the script level.

Some of the most common vulnerabilities that can expose sensitive user data include the leaking access control that enables reading of to restricted content such as credentials stored in a storage device. Due to inadequate access control, users who are not expected to see sensitive data may in fact be able to access it, even though the data is not referenced by the application in any way, gaining access to the computing device gives such users access to restricted content.

Another common cause is improperly managed sessions. When sessions are not managed properly, sessions processes and any sensitive content managed in such sessions are at risk of being exposed, and attackers can take advantage of this to cause massive leakage of sensitive data.

Further, insecure cryptographic storage is another major concern. Insecure cryptographic storage refers to unsafe practices of storing sensitive data, most prominently user passwords. This vulnerability is extra important because secure cryptographic storage is the last line of defense: strong cryptography saves the data once it has been exposed by other risks in an application. However, in the context of scripts being executed in a device, it is currently impossible to encrypt such sensitive data and prevent is from exposure due to the problem addressed as above.

In this disclosure is an invention that relates to the security of sensitive data executed by program scripts in a computing device, to address the challenges identified and improve the security of sensitive data executed by program scripts executed by a computing device.

### SUMMARY OF THE INVENTION

The following summary is an explanation of some of the general inventive steps for the system, method, architecture and apparatus in the description. This summary is not an extensive overview of the invention and does not intend to limit the scope beyond what is described and claimed as a summary.

In summary, the present invention relates to the security of sensitive data executed by program scripts in a computing device. A first file such as a program script comprising of a sequence of instructions that can be configured onto the memory and executed by a processor is stored in a storage device of the device. While conventionally sensitive data such as access keys would need to to be stored accessibly to the script, in the current invention, a suitable program comprising a sequence of instructions is configured on memory and coupled to an encrypted credential store only accessible to the program instance being executed by a processor. Further provided is an encrypted data store coupled to above said program is provided on the device's storage device. The successful execution of said first file such as a program script requires access to sensitive data such as but not limited to passwords, API keys or other sensitive parameters, which are provided at run-time by the program coupled to the encrypted credential store. The program is capable of accessing sensitive data in the encrypted data store without revealing the access or decryption keys to external programs and processes, and only to said first file such as a program script.

### BRIEF DESCRIPTION OF FIGURES

The invention is further described with respect to the embodiment as drawn in the accompanying figures:

FIG. 1 of the diagrams illustrates a device configuration for secure sensitive data execution by program scripts.

FIG. 2 of the diagrams is a method of secure execution of sensitive data by a program script.

FIG. 3 of the diagrams is a method performed by a suitable program according to this invention.

FIG. 4 of the diagrams is a method described embodying how the invention is used.

### DETAILED DESCRIPTION OF THE INVENTION

For purposes of this disclosure, file and script could be used interchangeably

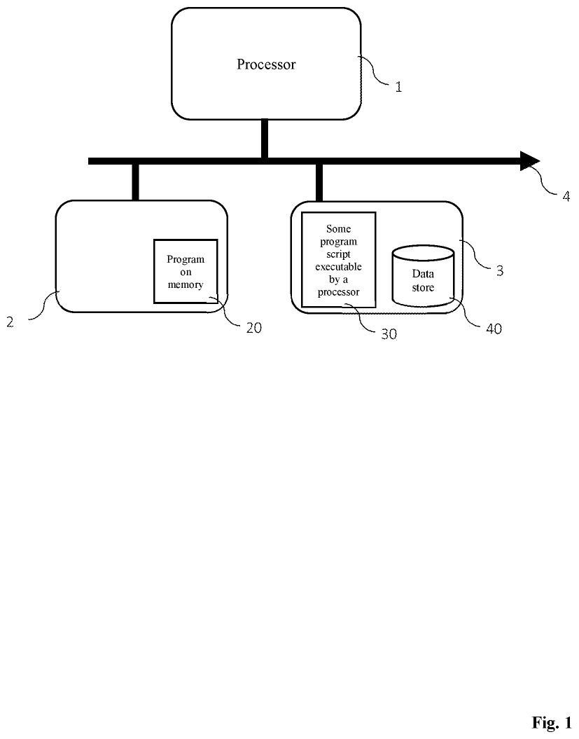

In a first embodiment according to FIG. 1 of the diagrams it is illustrated a device configuration for secure sensitive data execution by program files executed by the processor of a device. The devices comprises of a processor 1, a memory 2, a storage device 3 and a bus 4. In the invention, a first file such as a program script 30 stored in the storage device, whereby the file comprises of a sequence of instructions that can be configured onto the memory and executed by the processor. To sully execute its objective, the successful execution of said file's sequence of instructions by the processor when loaded on the memory requires access to sensitive data such as but not limited to passwords, API keys or other sensitive parameters. Such an objective could be the decryption of data required by the running of the instructions, access to a protected resource such as an application programming interface (API) or any such protected resources that require confidential and sensitive data for their access, or which by themselves would be considered sensitive such as but not limited to credit card information required to complete a payment instruction.

Typically, such sensitive data is provided to the file or script in either plain text, or as a hidden file in what is commonly known as the environment variables. However, even the hidden file would be accessible by an actor logged into the computing device. As such, said sensitive data required for successful execution of the script by the processor is provided at script run-time by a suitably provided program configured to provide access to sensitive data required for the successful execution of said script's sequence of instructions. In its essence, a suitable program that provides access to sensitive data is any such program comprising a sequence of instructions configured on memory and coupled to an encrypted credential store 40 only accessible to the program instance being executed by the processor. The program is capable of accessing sensitive data in the encrypted data store without revealing the access or decryption keys, and is also capable of of storing sensitive data in the encrypted data store inaccessible to any external programs or processes. In its essence, the program is needed with self-encrypted data whereby the key to access the encrypted credential store 40 must not be visible from outside, therefore the key must e.g be compiled inside the program and be protected against decompilation or other methods of analysis. Alternatively, the access key could be protected using any such suitable method, such as a key that is stored in a filesystem for which only the program has access to. It is not preferable that it is protected with a password with which the program and its data can be access from outside.

Further still, the suitable program could be made capable of detecting the execution of the provided first file such as a program script 30 by the processor and to provide access to sensitive data such as access keys or password to said script at run-time. For instance, by detecting the running processes, the program could subsequently avail access to the sensitive data to the process running the first file such as a program script. It could also be configured to remove access to the sensitive data such as access keys to said script wherein said script is not being executed. The program could further be configured capable of causing the execution of provided first file such as a program script by the processor and to provide access to sensitive data such as access keys to said script at run-time. Notably, the access could be a set of parameters passed to the first file such as a program script during its run-time, or a temporary file created by the program on the storage device containing sensitive to provide access to sensitive data such as access keys. In the case where a file is created, the program is capable of removing said temporary file created on the storage device containing sensitive data to remove access to sensitive data such as access keys where the execution of provided first file such as a program script by the processor is stopped.

The provision of access to sensitive data by the suitable program 20, may further depend upon certain conditions such as time, date, or any such conditions detectable by said program for example users logged into the device. Moreover, the sensitive data in the encrypted data store 40 could be tracked by a publicly available unique identifier, public in the context of the processing environment, that is not related to stored credentials. For the purposes of creating, removing and altering the contents of the encrypted data store 40, a suitable mechanism of accessing the program is provided. The program is capable of allowing a user access to it, and by extension the encrypted data store without revealing the contents of the store to any other external programs and processes, external in the context of the processing environment of the device.

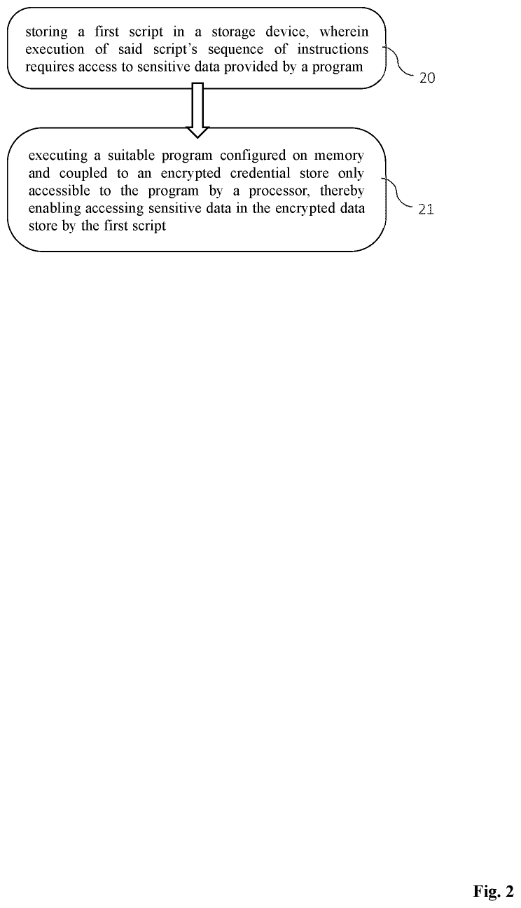

In a second embodiment according to FIG. 2 of the diagrams is an illustration a method of secure execution of sensitive data executed by a program script. The first step 20 entails the storing a first file such as a program script 30 in a storage device 3, the script being comprised of a sequence of instructions that can be configured onto the memory and executed by a processor, whereby the successful execution of said script's sequence of instructions requires access to sensitive data such as but not limited to passwords, API keys or other sensitive parameters, and said sensitive data is provided at run-time by a suitably provided program configured to secure sensitive data required for the successful execution of said script's sequence of instructions in an encrypted data store 40. The second step 21 entails the executing a suitable program 20 comprising a sequence of instructions configured on memory and coupled to the encrypted credential store only accessible to the program and its processes. The execution of the program by the processor enables the provision of access to sensitive data in the encrypted data store by the first file such as a program script 30 at run-time without revealing the access or decryption keys to any external processes and programs. It is inherently important that the program 20 is capable of storing sensitive data in the encrypted data store inaccessible to any external programs or processes, or even capable of determining the execution of said first file such as a program script stored in storage device for fool-proof security.

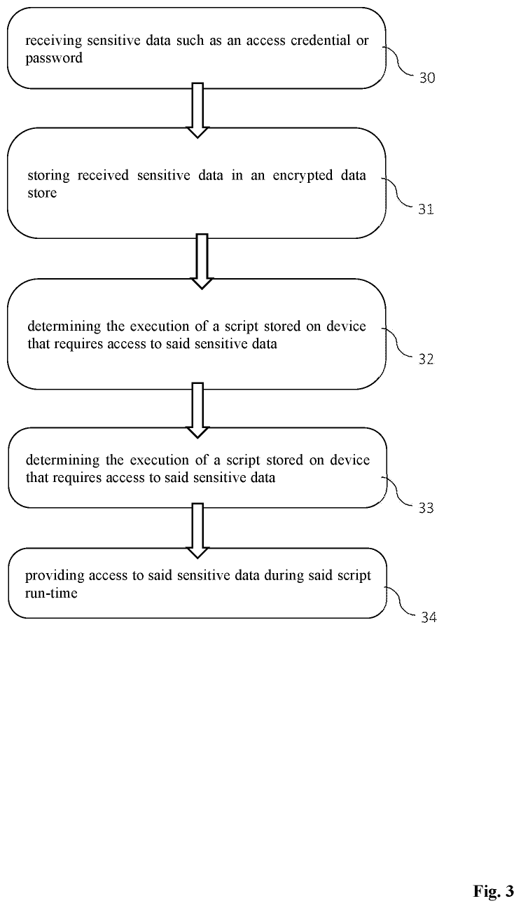

In a further embodiment according to FIG. 3 of the diagrams is a method performed by a suitable program configured on memory and executed by a processor. In the first step 30 is the receiving sensitive data such as an access credential or password, preferably from a user with sufficient access privileges and authority to protect such sensitive data. The next step 31 is the storing received sensitive data in an encrypted data store, labeled 40 in the FIG. 1. The subsequent step 32 is the determining the execution of a script stored on device that requires access to said sensitive data. In 33, it is the step of receiving a request from said first file such as a program script 30 stored on device for said sensitive data, and finally in the step 34 is the provision of access to said sensitive data during said first file such as a program script's run-time. Noteworthy, the stored sensitive data could be identifiable by a unique identifier, whereby the first file such as a program script requests said program access to sensitive data using the sensitive data's unique identifier. Furthermore, conditional mechanism could be implemented, wherein access to said sensitive data is limited to only certain conditions including but not limited to the date, time or any such conditions determinable by said suitable program. It is also the object of this invention to send an alert if conditions for access are breached by a stored first file such as a program script 30.

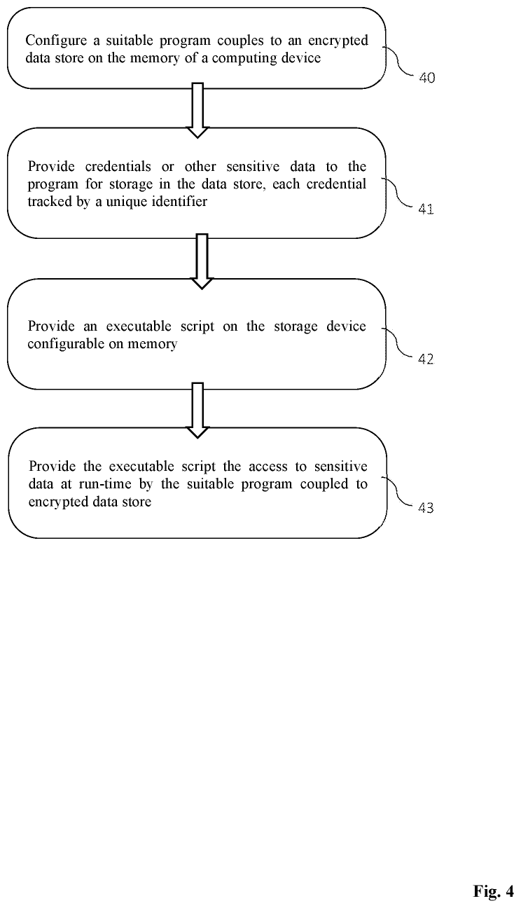

In the final embodiment according FIG. 4 of the diagrams is a method described embodying how the invention is used. In the first step 40 is the configuration of a suitable program coupled to an encrypted data store on the memory of a computing device, such that data in the data store is not accessible to external programs and processes. In the subsequently step 41 is the provision of credentials or other sensitive data to the program for storage in the data store, each credential tracked by a unique identifier, preferably by a user with sufficient rights over the sensitive data. In the next step 42 is the provision of an executable script on the storage device configurable on memory with an executable sequence of instructions to be performed by the processor. The final step 43 is the provision to the executable script the access to sensitive data at run-time by the suitable program coupled to encrypted data store.

### INDUSTRIAL APPLICATION

The current invention technology is applicable in the security industry.

1. A computing device comprising of:
a first file, such as but not limited to a program script, stored in a storage device comprising of a sequence of instructions that can be configured onto the memory and executed by a processor, wherein:
the successful execution of said script's sequence of instructions requires access to sensitive data such as but not limited to passwords, API keys or other sensitive parameters, and;
said sensitive data is provided at script run-time by a suitably provided program configured to secure sensitive data required for the successful execution of said script's sequence of instructions;
a suitable program comprising a sequence of instructions configured on memory and coupled to an encrypted credential store only accessible to the program instance being executed by a processor, wherein:
the said program is capable of accessing sensitive data in the encrypted data store without revealing the access or decryption keys, and;
said program is capable of of storing sensitive data in the encrypted data store inaccessible to any external programs or processes;
an encrypted data store coupled to above said suitable program, and comprising of sensitive data only accessible to the said program and no external programs or processes;
a memory;
a processor, and;
a storage device.

2. The computing device as in claim 1, wherein said suitable program is capable of detecting the execution of provided first file, by the processor and to provide access to sensitive data such as access keys to said script at run-time.

3. The computing device as in claim 1, wherein said suitable program is capable of detecting the execution of provided first file by the processor and to remove access to sensitive data such as access keys to said script wherein said script is not being executed.

4. The computing device as in claim 1, wherein said suitable program is capable of causing the execution of provided first file such as a program script by the processor and to provide access to sensitive data such as access keys to said script at run-time.

5. The computing device as in claim 2, wherein said suitable program is capable of creating a temporary file on the storage device containing sensitive data to provide access to sensitive data such as access keys wherein execution of provided first file by the processor is detected.

6. The computing device as in claim 5, wherein said suitable program is capable of removing said temporary file created on the storage device containing sensitive data for providing access to sensitive data such as access keys wherein execution of provided first file by the processor is stopped.

7. The computing device as in claim 1, wherein said suitable program is capable of providing access to sensitive data such as access keys to said script wherein said script is being executed in certain conditions only, including but not limited to time, date, or any such conditions detectable by said program for example users logged into the device.

8. The computing device as in claim 1, wherein said sensitive data in said encrypted data store is tracked by a publicly available unique identifier that is not related to stored credentials.

9. The computing device as in claim 1, wherein said program is capable of allowing a user access to it, and by extension the encrypted data store without revealing the contents of the store to any other external programs and processes.

10. A method of secure execution of sensitive data executed by a file such as program script, the method comprising of:
storing a first file such as a program script in a storage device, the file comprising of a sequence of instructions that can be configured onto the memory and executed by a processor, wherein:
the successful execution of said file's sequence of instructions requires access to sensitive data such as but not limited to passwords, API keys or other sensitive parameters, and;
said sensitive data is provided at run-time by a suitably provided program configured to secure sensitive data required for the successful execution of said file's sequence of instructions;
executing a suitable program comprising a sequence of instructions configured on memory and coupled to an encrypted credential store only accessible to the program and its process, wherein the execution of said program by the processor enables accessing sensitive data in the encrypted data store by the first file such as a program script at run-time without revealing the access or decryption keys to the encrypted data store.

11. The method as in claim 10, wherein said suitable program is capable of allowing a user access to it, and by extension the encrypted data store without revealing the contents of the store to any other external programs and processes.

12. The method as in claim 10, wherein said program is capable of storing sensitive data in the encrypted data store inaccessible to any external programs or processes.

13. The method as in claim 10, wherein said program is capable of determining the execution of said first file such as a program script stored in storage device.

14. A method performed by a suitable program configured on memory and executed by a processor, the method comprising of:
receiving sensitive data such as API keys, access credentials or passwords;
storing received sensitive data in an encrypted data store;
determining the execution of a first file, such as a program script, stored on device that requires access to said stored sensitive data;
receiving a request from said first file stored on device for said sensitive data, and;
providing access to said sensitive data during said first file run-time.

15. The method as in claim 14, wherein said stored sensitive data is identifiable by a unique identifier.

16. The method as in claim 15, wherein said file requests said program access to said sensitive data using said sensitive data unique identifier.

17. The method as in claim 14, further comprising receiving a conditional mechanism wherein access to said sensitive data is limited to only certain conditions including but not limited to the date, time or any such conditions determinable by said suitable program.

18. The method as in claim 17, further comprising sending an alert if conditions for access are breached by a stored first file such as a program script.

19. A method of providing secure execution of sensitive data executed by a file such program script, the method comprising of:
providing a suitable program configured on the memory and coupled to an encrypted data store on the memory of a computing device, such that data in the data store is not accessible to external programs and processes;
providing of credentials or other sensitive data to the program for storage in the encrypted data store, each credential tracked by a unique identifier;
providing of an executable file on the storage device configurable on memory with an executable sequence of instructions to be performed by the processor, and;
providing to the executable file the access to sensitive data at run-time by the suitable program coupled to encrypted data store.
